(19) United States
(12) Patent Application Publication
(10) Pub. No.: US 2008/0161439 A1
(43) Pub. Date: Jul. 3, 2008

(54) Novel polyisocyanurate foam materials

(76) Inventor: Malay Nandi, Littleton, CO (US)

Correspondence Address: JOHNS MANVILLE, 10100 WEST UTE AVENUE, PO BOX 625005, LITTLETON, CO, 80162-5005, US

(21) Appl. No.: 11/648,503

(22) Filed: Dec. 28, 2006

(51) Int. Cl. C08G 18/00

(52) U.S. Cl. 521/155

(57) ABSTRACT

Provided is a novel polyisocyanurate foam composition. The composition comprises an isocyanate reactive compound, polyisocyanate and an aqueous polymer emulsion. The unique foam can be synthesized without a blowing agent. and provides a foam material that is economical but still exhibits excellent foam properties.

### BACKGROUND OF THE INVENTION

1. Field of the Invention

This invention relates to rigid closed cell polyisocyanurate foam containing an aqueous polymer emulsion as a filler.

The present invention also relates to a polyisocyanurate foam composition comprising isocyanate reactive compounds, polyisocyanurates, and an aqueous polymer emulsion as a filler.

2. Description of the Related Art

The manufacture of flexible faced, rigid polyisocyanurate foam insulation boardstock is commonly practiced by a process called restrained rise lamination. The restrained rise process relies on a combination of chemical component blending, precision metering, reactive component mixing and dispensing, use of a moving opposed platen pressure laminator, and use of dimensioning finishing equipment.

In the traditional restrained rise process, isocyanate (“Component A”) is used as received. Component A is supplied by pump to a metering unit, or a metering pump. A premix (“Component B”) containing polyol, expansion agent, catalyst and surfactant is prepared according to a defined formulation in a mix tank. Component B is also supplied by pump to a metering unit, or a metering pump. The metering pumps boost the pressure generally to 2000 to 2500 psi and control the flow of Components A and B to a precise ratio as determined by the desired chemistry. The pumps deliver Components A and B to at least one foam mixhead. Inside the mixhead, the Components A and B are impinged against each other at high pressure, which results in intimate mixing of the components.

The mixed chemicals exit the mixhead and are dispensed onto a moving bottom facing sheet in a plurality of discrete, liquid streams, in a quantity depending on the type and thickness of desired final boardstock product. The facing sheet carrying the chemical streams then enters a pressure laminator. The spacing, or gap, between the top and bottom platens of the laminator is set to approximately the final desired thickness of boardstock. The laminator temperature is adjusted typically to about 120 to 150° F. to insure that no heat is lost from the reacting, exothermic chemical mix, and to insure that the facings adhere well to the rising foam.

The mixed chemicals begin to react in about 5 to 10 seconds following mixing, expanding about 35 to 40 times in volume in the laminator and completing reaction in about 35 to 45 seconds. Laminator speed is adjusted to insure that complete reaction occurs within the pressure section of the laminator. The reaction rate is adjusted by catalyst modification to optimize chemical mixture “flow.” Flow is a property of the reacting, rising foam by which expansion is controlled in such a manner that the foam properly expands both upward and sideways to fully fill the moving cavity defined by the laminator. This reactivity adjustment is essential to control both the overall properties of the final product and the cost of manufacture. Improper flow results in poor foam cell geometry which can deteriorate physical, thermal and flammability properties, and causes excessive densification of foam layers in contact with facings.

Rigid boardstock, with facing firmly attached, exits the laminator. This boardstock is trimmed to the desired final width and length. Finished product is conveyed to packaging equipment.

Much of the art in the manufacture of foamed polyisocyanurate takes place where the mixed chemical streams are laid onto the bottom facer prior to entering the laminator. It is necessary that the chemical streams be placed and configured properly to insure that the potential negative effects of the rising foam (e.g., densification of foam at the facer interface through sideways expansion) are minimized. Proper chemical system catalysis is also essential to insure that the rising foam flows properly. Process line speed must be balanced with the foam reactivity so that flow is preserved and the finished boardstock has reached sufficient hardness to be further processed.

When done properly, acceptable foam physical, thermal and flammability properties are achieved. The density spread between core foam density and the in-place density, or IPD, is minimized (core foam density is defined as the measured density of the foam section of one half the thickness of the board taken from the center of the thickness; in-place density is defined as the total quantity of foam chemicals in a complete section of board including layers of surface densification and chemical that has been absorbed into the facers). Typical values for core foam density versus IPD for restrained rise process foam boardstock are 1.75 lb/ft³ for core foam density and 1.95 lb/ft³ for IPD. However, imbalance of laydown, catalyst and line speed can easily drive IPD well over 2.0 lb/ft³.

Typical maximum line speed for a restrained rise process is approximately 1.5 feet/min for each foot of laminator length. That is, a 70 foot long laminator will produce acceptable quality boardstock at 105 feet/min at minimal cost; a speed of 2.0 feet/min per foot of laminator can be achieved on certain products with catalyst modification and careful attention to operating parameters. It is advantageous to increase line speed, and therefore production capacities, to gain more output from a given piece of equipment.

While mechanical limitations (i.e., finishing saws, conveyors and packaging equipment) can be modified to accommodate higher line speeds by conventional means, maintenance of proper foam properties and cost efficiencies present a more difficult problem. Increased line speed reduces the laminator dwell time (the time that the reacting foam is inside the pressure laminator) and must be altered to complete foam reaction more quickly. As the reaction time is reduced, chemical flow is also altered resulting in a condition commonly known as “lock up.” When flow is lost, excessive densification at the foam/facer interface occurs, and cell geometry can be altered in a manner such that important properties, including compressive strength, dimensional stability, facer adhesion, insulation value and certain flammability characteristics, are deteriorated. It is therefore advantageous to remove or reduce the need for chemical flow as a component of the process.

Another known process for making flexible faced, rigid polyisocyanurate foam insulation boardstock is the free rise process. In this process, chemical laydown or distribution is accomplished through the use of a pair of matched, precision metering rolls. Chemicals are dispensed just upstream of the metering rolls. The gap between the rolls is adjusted to approximately 1/35 to 1/40 of the desired finished thickness of the boardstock. This small gap causes the dispensed chemical to form a “chemical bank” against the metering roll, forcing the chemical to spread across the full width of the bottom facer. A thin layer of mixed foam chemicals (approximately 1/35 to 1/40 of the desired finished thickness of the boardstock) is uniformly spread between the top and bottom facers. This composite then moves into a heated oven where the foam reaction is completed. Foam expands 35 to 40 times in volume and becomes sufficiently rigid for further processing. Final foam thickness is controlled by precision adjustment of the metering rolls. No mechanical restraint is utilized for thickness control, as with the restrained-rise process.

The free rise process does not require chemical flow. Dispensed and metered chemicals need only expand in the thickness dimension and not in the width dimension since the original laydown already accomplishes fall width application. By removing the need for flow, catalyst adjustments are made only to achieve complete reaction at the desired line speed without the negative impact of “locking up” the foam system. The free rise process is capable of speeds in excess of 250 feet/min.

An additional benefit of the free rise process is that density control is achieved within more efficient limits. Since sideways flow of expanding chemical does not occur, densification at the foam/facer interface is minimized. Density spreads of 1.70 lb/ft³ for core foam density and 1.75 lb/ft³ for IPD are routinely achieved.

The processing of polyisocyanurate foam materials has advanced such that excellent materials can now be prepared in an efficient manner. However, as with other polymeric material it is often desirable to reduce polymer content by incorporating lower cost inorganic filler and thereby reduce the overall cost. Incorporation of mineral filler is optimized based upon the properties and cost. In general, the inorganic filler such as CaCO₃, clay, silica, aluminum trihydrate, mica, fly ash, wollastonite, feldspar, MgCO₃, ZnCO₃, carbon black, activated carbon, graphite, TiO₂, calcium metasilicate, glass fiber, etc., affect the foam properties such as cell rupture, compressive strength, friability, dispersion, etc., thus limits its use in higher percentage. Interest exists in finding a filler that can be used which provides an economical foam material and which does not adversely impact the properties of the foam.

### SUMMARY OF THE INVENTION

Provided is a novel polyisocyanurate foam composition and foam material made therefrom. The composition comprises an isocyanate reactive compound, polyisocyanate and an aqueous polymer emulsion. The unique foam can be synthesized without a blowing agent and provides a foam material that is economical but still exhibits excellent foam properties.

### DETAILED DESCRIPTION OF THE PREFERRED EMBODIMENTS

Described herein is the synthesis of novel polyurethane/polyisocyanurate foams by using aqueous polymer emulsion as filler, additive and blowing agent. These foams are synthesized without a blowing agent such as pentane etc. The choice of polymer emulsion are, but not limited to, styrene-butadiene rubber, styrene-butadiene-styrene, ethylene-vinyl chloride, poly-vinylidene chloride, poly-vinyl alcohol, ethylene-vinyl acetate, poly-vinyl acetate, actylonitrile, actylic copolymers and homopolymers, core-shell rubber, etc. The novelty of this work is the incorporation of an aqueous polymer emulsion to make a unique foam. The cell geometry is varied based on the selection of the polymer emulsion. The uniqueness of this foam is in its cell anisotropy, and is reflected in compressive strength, R values, etc. The impact and tensile properties of the foam are manipulated by careful selection of the polymer latex. The initial findings suggest that the friability and reactivity issues associated with water blown rigid polyurethane/polyisocyanurate foam are eliminated. It is the unique water blown foam that comparable with the foam where pentane or similar blowing agents are used. The insulation characteristic of this new foam would improve over aging. Overall, the properties of the foam are tuned by polymer emulsion/latex to custom fit the market applications. This invention is not limited to foam formulations without pentane, CO₂ or other blowing agents. Addition and incorporation of normally used blowing agents or other low boiling liquids or gases is feasible and could lead to different properties. The invention also relates to industrial roofing system and sheathing board based on such foams and the process of constructing such systems.

The density of the foam can range from 1.0 to 25 lb/ft³. This foam can be faced with paper or glass mat, preferably coated glass mat. Such foam board can have application as cover board in the commercial and industrial roofing construction and sheathing board for wall insulation, weather resistant and structure Integrity.

In the broadest aspects of the present invention, any organic polyisocyanate can be employed in the preparation of the rigid polyisocyanurate foams. The organic polyisocyanates which can be used include aromatic, aliphatic and cycloaliphatic polyisocyanates and combinations thereof. Such polyisocyanates are described, for example, in U.S. Pat. Nos. 4,795,763, 4,065,410, 3,401,180, 3,454,606, 3,152,162, 3,492,330, 3,001,973, 3,394,164 and 3,124,605, all of which are incorporated herein by reference.

Representative of the polyisocyanates are the diisocyanates such as m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, diphenyl methane-4,4′-diisocyanate, 4,4′-diphenylenediisocyanate, 3,3′-dimethoxy-4,4′-biphenyl-diisocyanate, 3,3′-dimethyldiphenylmethane-4,4′-diisocyanate; the triisocyanates such as 4,4′,4′-triphenylmethane-triisocyanate, polymethylenepolyphenyl isocyanate, toluene-2,4,6-triisocyanate; and the tetraisocyanates such as 4,4′-dimethyldiphenylmethane-2,2′,5,5′-tetraisocyanate. Suitable polyisocyanate includes aliphatic and aromatic polyisocyanates, such as poly(isocyanatophenylmethylene), phenylisocyanate, 2,4-toluenediisocyanate, 2,6-toluenediisocyanate, 2,4′-diphenylmethanediisocyanate, 4,4′-diphenylmethanediisocyanate, hexamethylenediisocyanate, isophoronediisocyanate, 1,4-cyclohexanediisocyanate (U.S. Pat. No. 4,661,533, U.S. Pat. No. 4,065,410, U.S. Pat. No. 3,401,180, U.S. Pat. No. 3,454,606, U.S. Pat. No. 3,152,162, U.S. Pat. No. 3,492,330, U.S. Pat. No. 3,001,973, U.S. Pat. No. 3,394,164, U.S. Pat. No. 3,124,605, U.S. Pat. No. 4,108,791) and the like.

Prepolymers may also be employed in the preparation of the foams of the present invention. These prepolymers are prepared by reacting an excess of organic polyisocyanate or mixtures thereof with a minor amount of an active hydrogen-containing compound as determined by the well-known Zerewitinoff test, as described by Kohler in “Journal of the American Chemical Society,” 49, 3181(1927). These compounds and their methods of preparation are well known in the art. The use of any one specific active hydrogen compound is not critical hereto, rather any such compound can be employed in the practice of the present invention.

Preferred isocyanates used according to the present invention include Mondur 489 (Bayer), Rubinate 1850 (ICI), Luprinate M70R (BASF) and Papi 580 (Dow). Isocyanate indices greater than about 200 are preferred, particularly from about 225 to about 325.

In addition to the polyisocyanate, the foam-forming formulation also contains an organic compound containing at least 1.8 or more isocyanate-reactive groups per molecule. Preferred isocyanate-reactive compounds are the polyester and polyether polyols. Such polyester and polyether polyols are described, for example, in U.S. Pat. No. 4,795,763. Isocyanate reactive compounds include polyols, polyamines, polyacids, polymercaptons (U.S. Pat. No. 4,394,491, U.S. Pat. No. 3,383,351, U.S. Pat. No. 3,652,639, U.S. Pat. No. 3,623,201, U.S. Pat. No. 3,953,393, and U.S. Pat. No. 3,869,413). These compounds could be derived from petroleum based raw materials or renewable resources such as soybean oil, castor oil, linseed oil, tall oil etc (Journal of Polymers and the Environment, Vol. 12, No. 3, July 2004, Page 123).

The polyester polyols useful in the invention can be prepared by known procedures from a polycarboxylic acid or acid derivative, such as an anhydride or ester of the polycarboxylic acid, and a polyhydric alcohol. The acids and/or the alcohols may be used as mixtures of two or more compounds in the preparation of the polyester polyols.

The polycarboxylic acid component, which is preferably dibasic, may be aliphatic, cycloaliphatic, aromatic and/or heterocyclic and may optionally be substituted, for example, by halogen atoms, and/or may be unsaturated. Examples of suitable carboxylic acids and derivatives thereof for the preparation of the polyester polyols include: oxalic acid; malonic acid; succinic acid; glutaric acid; adipic acid; pimelic acid; suberic acid; azelaic acid; sebacic acid; phthalic acid; isophthalic acid; trimellitic acid; terephthalic acid; phthalic acid anhydride; tetrahydrophthalic acid anhydride; pyromellitic dianhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dibasic and tribasic unsaturated fatty acids optionally mixed with monobasic unsaturated fatty acids, such as oleic acid; terephthalic acid dimethyl ester and terephthalic acid-bis-glycol ester.

Any suitable polyhydric alcohol may be used in preparing the polyester polyols. The polyols can be aliphatic, cycloaliphatic, aromatic and/or heterocyclic, and are preferably selected from the group consisting of diols, triols and tetrols. Aliphatic dihydric alcohols having no more than about 20 carbon atoms are highly satisfactory. The polyols optionally may include substituents which are inert in the reaction, for example, chlorine and bromine substituents, and/or may be unsaturated. Suitable amino alcohols, such as, for example, monoethanolamine, diethanolamine, triethanolamine, or the like may also be used. Moreover, the polycarboxylic acid(s) may be condensed with a mixture of polyhydric alcohols and amino alcohols.

Examples of suitable polyhydric alcohols include: ethylene glycol; propylene glycol-(1,2) and -(1,3); butylene glycol-(1,4) and -(2,3); hexane diol-(1,6); octane diol-(1,8); neopentyl glycol; 1,4-bishydroxymethyl cyclohexane; 2-methyl-1,3-propane diol; glycerin; trimethylolpropane; trimethylolethane; hexane triol-(1,2,6); butane triol-(1,2,4); pentaerythritol; quinitol; mannitol; sorbitol; formitol; α-methyl-glucoside; diethylene glycol; triethylene glycol; tetraethylene glycol and higher polyethyleneglycols; dipropylene glycol and higher polypropylene glycols as well as dibutylene glycol and higher polybutylene glycols. Especially suitable polyols are oxyalkylene glycols, such as diethylene glycol, dipropylene glycol, triethylene glycol, tripropylene glycol, tetraethylene glycol, tetrapropylene glycol, trimethylene glycol and tetramethylene glycol.

Particularly preferred polyester polyols include Stepanpol PS2352 (Stepan) and Terate 2541 (Hoechst Celanese). Preferred amounts of the polyester polyols are consistent with isocyanate indices greater than 200, preferably between about 225 and 325.

Polyether polyols useful according to the present invention include the reaction products of a polyfunctional active hydrogen initiator and a monomeric unit such as ethylene oxide, propylene oxide, butylene oxide and mixtures thereof, preferably propylene oxide, ethylene oxide or mixed propylene oxide and ethylene oxide. The polyfunctional active hydrogen initiator preferably has a functionality of 2-8, and more preferably has a functionality of 3 or greater (e.g., 4-8).

A wide variety of initiators may be alkoxylated to form useful polyether polyols. Thus, for example, poly-functional amines and alcohols of the following type may be alkoxylated: monoethanolamine, diethanolamine, triethanolamine, ethylene glycol, polyethylene glycol, propylene glycol, hexanetriol, polypropylene glycol, glycerine, sorbitol, trimethylolpropane, pentaerythritol, sucrose and other carbohydrates. Such amines or alcohols may be reacted with the alkylene oxide(s) using techniques known to those skilled in the art. The hydroxyl number which is desired for the finished polyol would determine the amount of alkylene oxide used to react with the initiator. The polyether polyol may be prepared by reacting the initiator with a single alkylene oxide, or with two or more alkylene oxides added sequentially to give a block polymer chain or at once to achieve a random distribution of such alkylene oxides. Polyol blends such as a mixture of high molecular weight polyether polyols with lower molecular weight polyether polyols can also be employed.

If desired a blowing agent can be used. Any suitable blowing agent can be employed in the foam compositions of the present invention. In general, these blowing agents are liquids having a boiling point between minus 50° C. and plus 100° C. and preferably between 0° C. and 50° C. The preferred liquids are hydrocarbons or halohydrocarbons such as chlorinated and fluorinated hydrocarbons. Suitable blowing agents include HCFC-141b (1-chloro-11-difluoroethane), HCFC-22 (monochlorodifluoromethane), HFC-245 fa (1,1,1,3,3-pentafluoropropane), HFC-134a (1,1,1,2-tetrafluoroethane), H FC-365mfc (1,1,1,3,3-pentafluorobutane), cyclopentane, normal pentane, isopentane, LBL-2(2-chloropropane), trichlorofluoromethane, CCl₂ FCClF₂, CCl₂ FCHF₂, trifluorochloropropane, 1-fluoro-1,1-dichloroethane, 1,1,1-trifluoro-2,2-dichloroethane, methylene chloride, diethylether, isopropyl ether, methyl formate, carbon dioxide and mixtures thereof.

The foams also can be produced using a froth-foaming method, such as the one disclosed in U.S. Pat. No. 4,572,865. In this method, the frothing agent can be any material which is inert to the reactive ingredients and is easily vaporized at atmospheric pressure. The frothing agent advantageously has an atmospheric boiling point of −50° to 10° C., and includes carbon dioxide, dichlorodifluoromethane, monochlorodifluoromethane, trifluoromethane, monochlorotrifluoromethane, monochloropentafluoroethane, vinylfluoride, vinylidenefluoride, 1,1-difluoroethane, 1,1,1-trichlorodifluoroethane, and the like. A higher boiling blowing agent is desirably used in conjunction with the frothing agent. The blowing agent is a gaseous material at the reaction temperature and advantageously has an atmospheric boiling point ranging from about 100 to 80° C. Suitable blowing agents include trichloromonofluoromethane, 1,1,2-trichloro-1,2,2-trifluoroethane, acetone, pentane, and the like. In the froth-foaming method, the foaming agents, e.g., trichlorofluoromethane blowing agent or combined trichlorofluoromethane blowing agent and dichlorodifluoromethane frothing agent, are employed in an amount sufficient to give the resultant cured foam the desired bulk density which is generally between 0.5 and 10, preferably between 1 and 5, and most preferably between 1.5 and 2.5, pounds per cubic foot.

The foaming agents generally comprise from 1 to 30, and preferably comprise from 5 to 20 weight percent of the composition. When a foaming agent has a boiling point at or below ambient, it is maintained under pressure until mixed with the other components. Alternatively, it can be maintained at subambient temperatures until mixed with the other components. Mixtures of foaming agents can be employed.

Any suitable surfactant can be employed in the foams of this invention, including silicone/ethylene oxide/propylene oxide copolymers. Examples of surfactants useful in the present invention include, among others, polydimethylsiloxane-polyoxyalkylene block copolymers available from Witco Corporation under the trade names “L-5420”, “L-5340”, and Y10744; from Air Products under the trade name “DC-193”; from Goldschmidt under the name, Tegostab B84PI; and Dabco DC9141. Other suitable surfactants are those described in U.S. Pat. Nos. 4,365,024 and 4,529,745. Generally, the surfactant comprises from about 0.05 to 10, and preferably from 0.1 to 6, weight percent of the foam-forming composition.

Additives include surfactant (silicon, phosphorus, fluorine and the like), catalyst (triethyl amine, benzyldimethylamine, triethylenediamine, potassium t-butoxide, sodium borohydride, hydroxides of quarternery nitrogen, sodium formate, sodium benzoate, potassium acetate, calcium diacetate, potassium octoate, N,N-dimethylethanol amine, N-ethylmorpholine, tetramethylbutane diaminecarboxilic salts of tin, zinc, lead, mercury, cadmium, bismuth, antimony, iron, manganese, cobalt, copper, vanadium, and the like), colorants, mold release agent, flame retardant, antioxidants and the like.

Facings for use in the present invention include any flat, sheet material suitable to the required end application of the final board product. At least the upper facer must be flexible enough to be wrapped tightly around a metering roll. Facers must also be flat enough to not significantly alter the small gap between metering rolls. Such materials include aluminum foil/kraft paper laminations, bare aluminum foil, paper roof insulation facings, and coated glass fiber mats. A facer, as used herein, may also include oriented strandboard or gypsum, in which case such rigid material is conveyed to the laminator, and foam-forming mixture is preferably applied directly thereon.

The exemplary blowing agents are halogenated alkane include methylene chloride, monochloromonofluoromethane, dichlorodifluoromethane, dochforomonofluoromethane, difluoromonochloromethane, trichlorofluoromethane, cyclopentane, n-pentane, i-pentane, 1,1,1-trichloroethane, carbon dioxide, water and the like.

While the invention has been described in detail and with reference to specific embodiments thereof, it will be apparent to one skilled in the art that various changes and modifications can be made herein without departing from the spirit and scope thereof.

What is claimed is:

1. A polyisocyanurate foam composition comprising an isocyanate reactive compound, polyisocyanate and an aqueous polymer emulsion.

2. The composition of claim 1, wherein the isocyanate reactive compound is a polyol.

3. The composition of claim 1, wherein the composition further comprises a blowing agent.

4. The composition of claim 1, wherein the aqueous polymer emulsion is a styrene-butadiene emulsion.

5. The composition of claim 1, wherein the aqueous polymer emulsion is a rubber emulsion.

6. A rigid polyisocyanurate foam material prepared by foaming the composition of claim 1.

7. The foam material of claim 6, wherein the foam material is a board.

8. A process for preparing a rigid polyisocyanurate foam material which comprises foaming the composition of claim 1, and controlling the rise of the foam to the desired dimensions.
